(19) United States
(12) Patent Application Publication
(10) Pub. No.: US 2026/0242144 A1
(43) Pub. Date: Aug. 20, 2026

(54) IMPROVED COLUMN EQUIPMENT FOR STACKING AND TRANSPORTING PILED-UP ARTICLES

(71) Applicant: FERRERO S.p.A., Casalgrasso (Cuneo) (IT)

(72) Inventors: Fabrizio GIACHERO, Airasca (Torino) (IT); Simone CHIARLONE, Carmagnola (Torino) (IT)

(73) Assignee: FERRERO S.p.A., Casalgrasso (Cuneo) (IT)

(21) Appl. No.: 18/872,085

(22) PCT Filed: May 12, 2023
(86) PCT No.: PCT/IB2023/054927

§ 371 Date: Dec. 5, 2024

(30) Foreign Application Priority Data
Jun. 13, 2022 (IT) 102022000012443

(51) Int. Cl. B65G 1/14

(52) U.S. Cl. CPC B65G 1/14

(57) ABSTRACT

A column for equipment for stacking and transporting piled-up and vertically separated articles includes a plurality of superimposed swingable brackets suitable to support the articles. Each bracket has a rear body in which there are obtained means for pivoting the bracket to the support, the stop means, and the supports for the actuator means and for the return means of the bracket.

### FIELD OF THE INVENTION

The present invention regards a column for equipment for stacking and transporting piled-up and separated articles, in particular equipment comprising two or more columns of the type in which for each column there is provided for a plurality of superimposed swingable brackets suitable to support stacked articles, for example components of vehicle bodies, separated from each other vertically.

Often, the manufacturing of part of the components to be assembled in a production line, especially in the automotive industry, occurs in different factories with respect to where the assembly line is located. Furthermore, increasingly frequently, the assembly of components in an assembly line occurs in an automated manner, for example by means of robotic arms which pick up one article at a time from a storage container.

Therefore, there arises the need for containers provided with equipment for stacking and transporting a group of piled-up and vertically separated components capable of enabling them to be transported in a safe and reliable manner, that is compatible with the automated assembly means of a production line and which simultaneously has reduced production times and low costs.

### STATE OF THE PRIOR ART

Typically, these transportation containers consist of metal structures of various shapes and sizes provided with column-like equipment mentioned above.

Such columns usually comprise a channel-shaped body and a plurality of superimposed swingable brackets suitable to support the articles obtained by processing a metal sheet so as to form the means for coupling and actuating the bracket.

The principle of operation of the columns is based on the sequential loading and unloading of the articles which are placed on the brackets mechanically or manually.

The rotation of each bracket during the loading step can be divided into three steps. The brackets are initially in a retracted inoperative position, in which they are substantially contained in the body of the column. When an article is placed on a bracket, the contiguous bracket takes an intermediate pre-loading position, in which its section for supporting the articles is partially projecting from the body of the column to receive the subsequent article to be stacked and which, in turn, will rotate the bracket to an extracted loading position and the contiguous bracket to the pre-loading position.

During the unloading step, the bracket corresponding to the article that is removed returns to the initial inoperative position due to a counterweights or springs system. Thus, actuator means are provided for controlling the rotation of each bracket from the retracted position to the intermediate pre-loading position by a contiguous bracket and means for returning the bracket towards the retracted inoperative position.

Document EP-1505010 refers to automated structures for the storage and displacement of articles comprising columns provided with a plurality of swingable brackets. Each of the brackets is provided with at least one metal spring suitable to return the bracket to the inoperative position once the article is removed. In an embodiment, the springs can be replaced by counterweights formed on the rear section of the brackets. The connection between the brackets occurs by means of a rod slidably engaged with projections provided for laterally to the brackets, that is in the section opposite to the counterweight with respect to the rotation axis.

EP 0613837 describes columns provided with swingable brackets provided with torsion springs at the rotation axis suitable to return each bracket to the inoperative position.

DE 202009006057 refers to columns of the type described above wherein each bracket is connected to the overlying one by means of a rod pivoted by means of a slot to a pin provided at the joint between the central portion and the front portion of the bracket. Furthermore, a counterweight or a spring is provided in the rear section of each bracket.

The column for equipment for stacking and transporting piled-up and separated articles described in patent EP3453647 owned by Ferrero S.p.A. describes a column generally corresponding to the pre-characterising part of claim 1. The main drawback of this type of column lies both in the shape of the brackets, made of 3 sectors, and in the means for pivoting and stopping the brackets with the body of the column. Each of such brackets actually consists in a sheet folded and shaped into three different sections, that are difficult and expensive to make. Furthermore, such brackets require bushings for coupling with the pivoting means to the body of the column and, usually, they need to be coated with an anti-slip and/or anti-scratch material, increasing the times for assembling the column and therefore, the manufacturing costs.

### SUMMARY OF THE INVENTION

The object of the present invention is to overcome the aforementioned drawbacks, and to provide an improvement for a column thus made for equipment for stacking and transporting piled-up and separated articles which allows to drastically reduce the manufacturing costs thereof and the time required for the assembly thereof minimising the number of components and simplifying the processing thereof.

According to the invention, this object is mainly obtained due to the fact that, in compliance with the characterising part of claim 1, the means for pivoting each bracket to the support of the column, the stop means, the supports for the actuator means and the supports for the return means are obtained in a single rear body of the bracket. This allows to obtain, for example by moulding plastic material, compact, light, cost-effective brackets which do not require further elements for assembly on the support of the column, that are easy to assemble, and which have a high reliability extended over time.

In an embodiment according to the invention, the rear body of each bracket comprises a lateral protuberance protruding from the front body and provided with: a hole for a pivot pin inserted into a respective pair of holes provided for on the support defining the pivoting means, and stop surfaces each being inserted into a respective groove provided for on the support, and a rear protuberance provided with at least one lateral appendage coupled to the actuator and return means.

In a further embodiment, the rear body of each bracket comprises—a pair of first lateral cylindrical bodies protruding from the front body each having a proximal portion coupled with the return means, and a distal portion in the form of a pivot pin inserted into a respective hole provided for on the support,—a pair of second lateral cylindrical bodies parallel to the first cylindrical bodies, each provided with a proximal portion with larger diameter and a distal portion with smaller diameter inserted into a respective groove provided for on the support, wherein the groove has a curved slide section suitable to allow the passage of the distal portion of the respective cylindrical body during the rotation of the bracket between the inoperative and loading positions, and it is provided with end portions for support respectively in the loading position and in the inoperative position of the bracket, and—a protruding rear end portion, acting as an actuator means.

In a preferred embodiment according to the invention, the brackets are made of plastic, for example using conventional injection moulds or through 3D printing technologies.

In a further embodiment of the invention, the channel-shaped support of the column consists of a pair of crankcases connected to each other by means of suitable fixing means.

In a further embodiment of the invention, at least one of the end portions of the support has a pair of wings folded by 90° so as to define means for anchoring at least one support end. In further embodiments, both ends of the support have anchoring wings so as to prevent any misalignment of the brackets during the use thereof.

In a further embodiment, the actuator means and the return means comprise respective counterweights, or the return means comprise a spring.

In a further embodiment, the rear body of each of the brackets is inclined with respect to the front body.

The invention also relates to an equipment for stacking and transporting piled-up articles comprising at least two of the aforementioned columns.

The columns according to the invention can be used with equipment for stacking and transporting articles according to different configurations: the columns can be vertical and in this case the brackets in said extracted position extend horizontally, Or the columns are horizontal and the brackets in the aforementioned extracted position can extend horizontally or vertically. The columns can also be inclined and in this case the brackets in said extracted position extend vertically.

### BRIEF DESCRIPTION OF THE DRAWINGS

The invention will now be described in detail, purely by way of non-limiting example, with reference to the attached drawings, wherein:

FIG. 1 is a schematic perspective view of a first embodiment of a column for equipment for stacking and transporting piled-up articles according to the invention,

FIG. 2 shows a portion of FIG. 1 in larger scale,

FIG. 3 is an exploded schematic perspective view of FIG. 1,

FIG. 4 is an enlarged perspective view of a detail of FIG. 1,

FIG. 5 is a schematic perspective view of a second embodiment of a column for equipment for stacking and transporting piled-up articles according to the invention,

FIG. 6 is an exploded schematic perspective view of FIG. 5,

FIG. 7 is an enlarged perspective view of a detail of FIG. 5,

FIG. 8 shows a portion of FIG. 5 in larger scale,

FIG. 9 is a schematic perspective view of a further embodiment of a detail the column for equipment for stacking and transporting piled-up articles according to the invention,

FIGS. 10 and 11 perspectively show two variants of the swingable brackets of the column according to the invention.

### DETAILED DESCRIPTION OF THE INVENTION

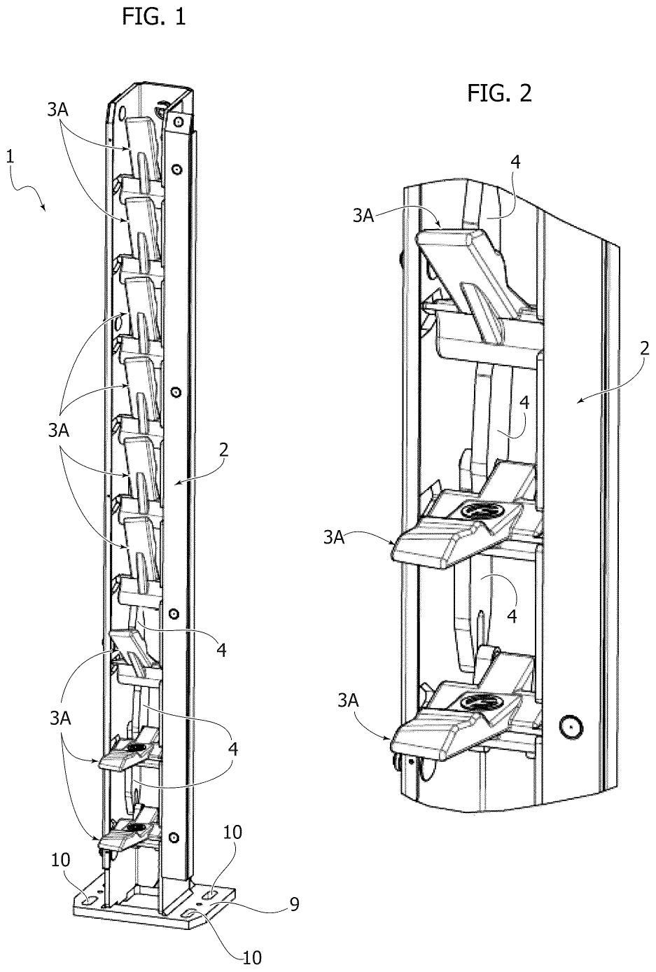

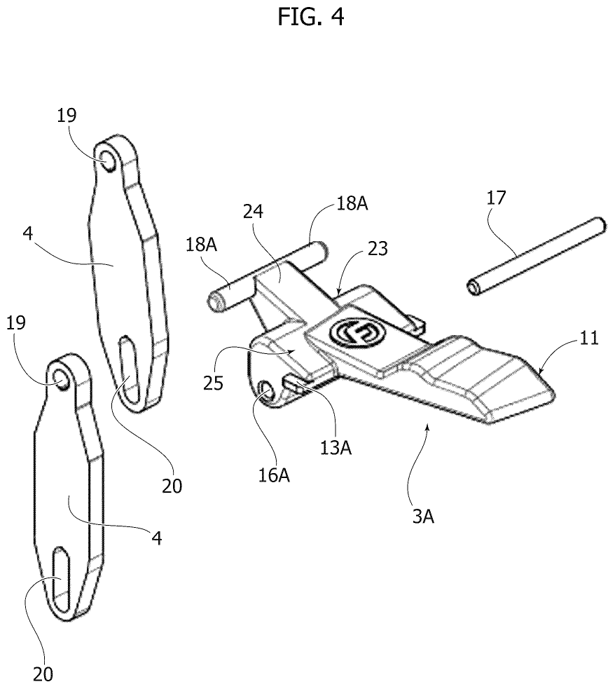

Initially referring to FIG. 1, a column for equipment for stacking and transporting piled-up articles is indicated in its entirety with 1 and it comprises, in a generally known manner, a channel-shaped support 2, better visible in FIG. 2, in which there are housed—in a superimposed manner—a plurality of swingable brackets 3A, each coupled with two counterweights 4, better visible in FIG. 4, as will be described hereinafter.

A pair of containment sheets 5 is applied to the lateral walls of the support 2, and a fixing bar 6 can be provided along one of the containment sheets 5.

The column 1 can be fixed to the floor of a container by means of a base 9 provided with holes and slots 10 for the bolts (not shown) to pass through.

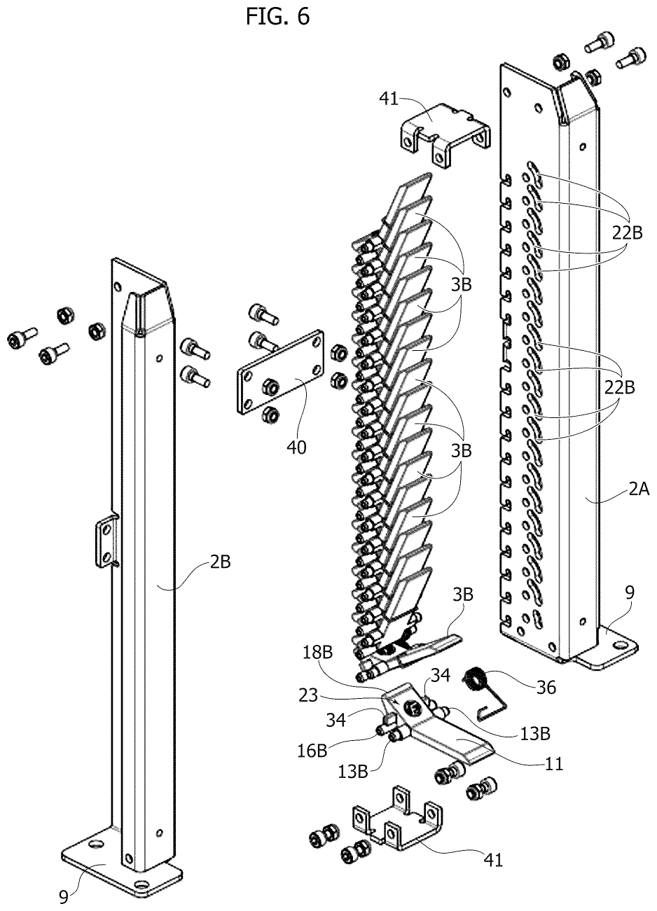

With reference to FIG. 6, in an embodiment of the column 1 according to the invention, the support 2 may be obtained by coupling a pair of crankcases 2A, 2B connected and fixed to each other by means of, for example, one or more fixing plates 40. This allows to further simplify the assembling of the column according to the invention, reducing production times and costs.

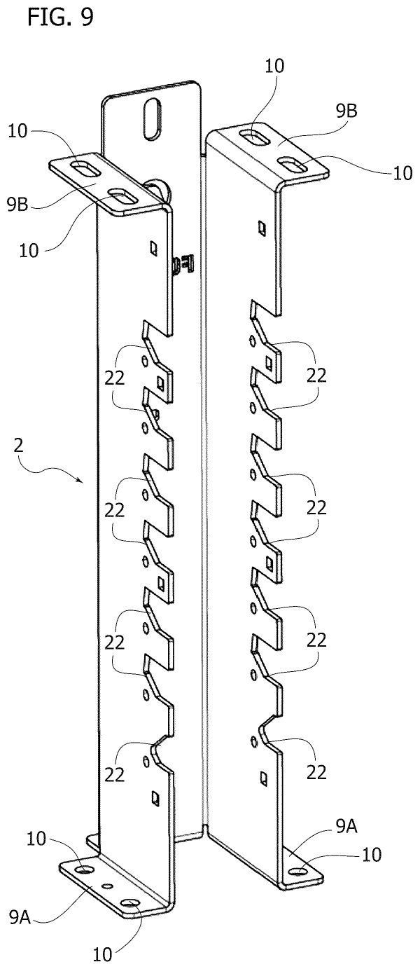

Now, with reference to FIG. 9, in a further embodiment according to the invention, the support 2 may be made as a single channel-shaped body provided with at least one of the end portions having a pair of wings 9A and/or 9B folded by 90° so as to define the fixing means of at least one end of the support 2. In FIG. 9 both end portions of the support 2 have respective pairs of wings 9A e 9B folded so as to allow a firmer fixing of the column 2 to the transportation container (not shown) avoiding any type of deformation thereof during use.

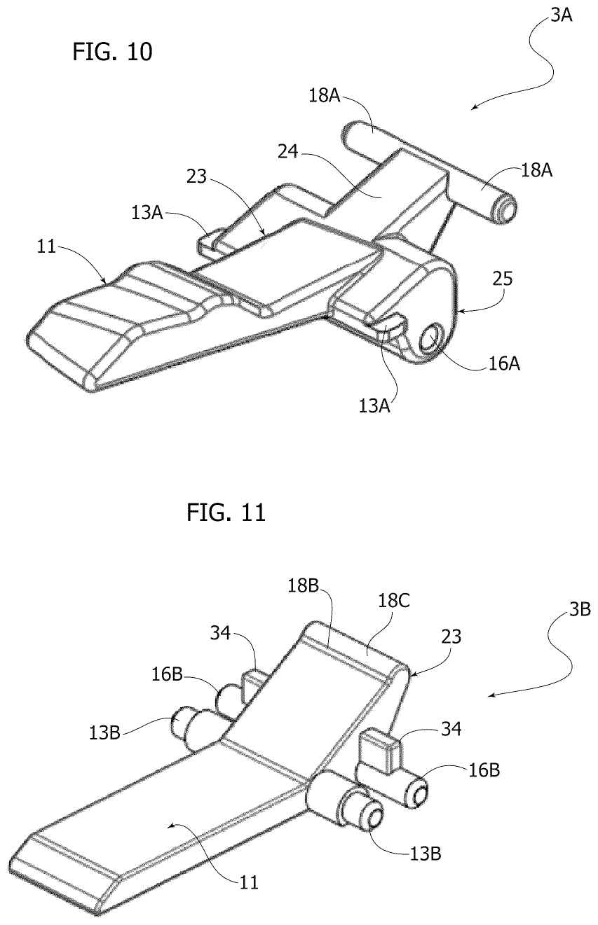

FIGS. 10 and 11 better show two embodiments of the brackets 3A,3B of the column 1 according to the invention, for example made of plastic material, in which each bracket 3A,3B has a front body 11 which has the function of supporting the articles (not shown), for example vehicle body parts. The shape of such front body 11 is purely for exemplifying purposes and it may vary as a function of the type and characteristics of the articles it will be required to support.

According to a distinctive characteristic of the invention, the brackets 3A and 3B comprise a thickened rear body 23 which has—on the lateral edges thereof—a pair of pivoting means 16A, 16B for the rotatable coupling of the bracket 3 with the support 2, as described below, stop means 13A, 13B substantially coplanar to the front body 11 arranged in proximity of the joint with the front body 11, and supports 18A,18B,34 for actuator means 4 and for return means 4,36 which will be addressed hereinafter.

Now, with reference to FIG. 10, in a first embodiment according to the invention, the pivoting means arranged on the rear body of the bracket 3A comprise a protruding lateral protuberance 25 provided with a lower hole 16A for a pivot pin 17 shown in FIG. 4. Protruding from both external front end portions of such protuberance 25 there is further obtained a pair of stop surfaces 13A. Furthermore, the rear body 23 of the bracket 3A is provided with a rear protuberance 24 provided with a pair of lateral appendages 18A for supporting the actuator and return means, in the form of counterweights 4 in this embodiment.

With reference to FIG. 4, the counterweights 4 generally have an elongated shape and they are provided with an upper hole 19 and with a lower slot 20 aligned with the upper hole 19.

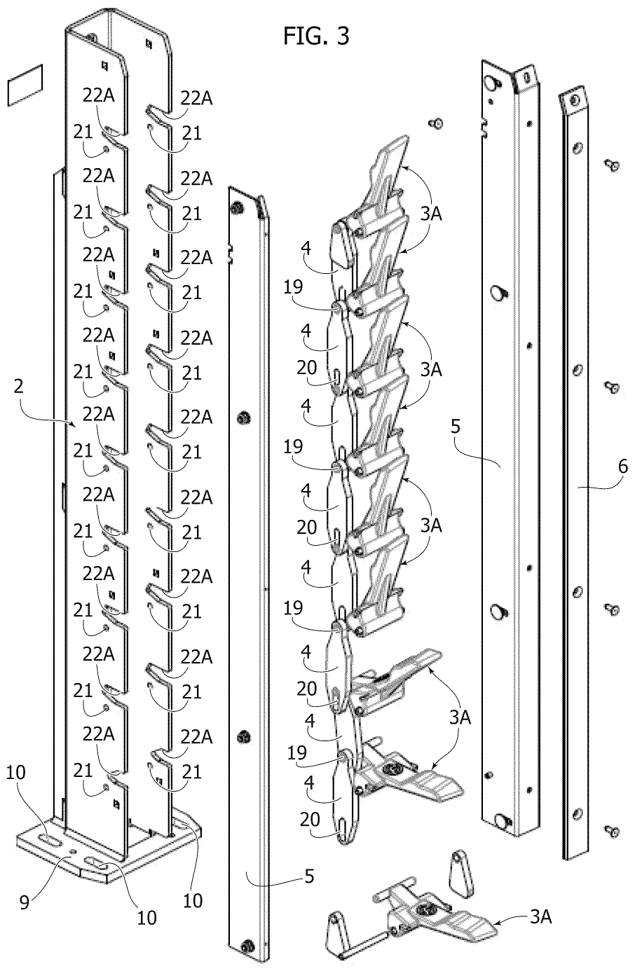

FIG. 2 shows—in detail—a portion of a first embodiment of the column 1 according to the invention which supports the tiltable brackets 3A, and FIG. 3 shows an exploded view of such column. In particular, on the side walls of the support 2 there is provided for a pair of lower holes 21 and a corresponding pair of upper grooves 22A for each bracket 3A. The grooves 22A are formed with an initial section having a substantially horizontal lower surface, an inclined slide intermediate section and a terminal section with a vertical surface.

Each bracket 3A is normally housed in the support 2 with the pivot pin 17 inserted into the respective pair of holes 21 of the support 2 and the stop surfaces 13A inserted into the respective pair of grooves 22A.

As better observable in FIG. 3, pairs of lower holes 21 and corresponding upper grooves 22A are provided uniformly over the entire length of the column 1 at pre-established intervals and, as a result, the brackets 3A are equally spaced apart from each other.

For each pair of counterweights 4 a lower counterweight 4 is connected to one of the lateral appendages 18A of a respective bracket 3A by means of the relative upper hole 19, and to the corresponding lateral appendage 18A of the underlying bracket 3A by means of the relative lower slot 20. In the embodiment shown in the drawings an upper counterweight 4 is connected to the same lateral appendage 18A of the bracket 3A by means of the respective lower slot 20 and to the corresponding lateral appendage 18A of the overlying bracket 3A by means of the respective upper hole 19. In an alternative embodiment of the invention, not shown in the drawings, the upper and lower counterweights 4-4 can be applied to both lateral appendages 18A of each bracket 3A.

In this manner, each of the brackets 3A, excluding the lower one and the upper one of the pile, is connected both to the overlying bracket 3A and to the underlying bracket 3A by means of respective counterweights 4.

As shown in FIGS. 2 and 3, each bracket 3A may rotate around the pivot pin 17 thereof between an inoperative substantially vertical raised position, in which it is substantially contained inside the support 2, an intermediate pre-loading inclined position in which the front body 11 of the bracket 3A is partially projecting from the support 2 to receive an article, and a substantially horizontal loading position in which the front body 11 is projecting from the support 2 to support the article.

In the initial configuration of the column 1, in the absence of stacked articles, all the brackets 3A are in the inoperative raised position except for the lower one of the stack which is arranged in the pre-loading position.

In the raised position the pair of stop surfaces 13A of each bracket 3A rests on the vertical surfaces of the terminal sections of the respective grooves 22A, determining—as a result—the upper stop position of the rotation of the bracket 3A. Such raised configuration is maintained by means of the lower counterweight 4 hung on the lateral appendage 18A while the upper counterweight 4 is in an inoperative position in which the lateral appendage 18A is positioned in the lower part of the slot 20.

In the loading position of the brackets 3A, the stop surfaces 13A of each bracket 3A rest on the horizontal surfaces of the initial sections of the respective grooves 22A, therefore determining the lower stop position.

The column 1 according to the invention operates as follows.

When a first article is positioned on the lower bracket 3A, it rotates in the loading position due to the weight of the article by actuating its upper counterweight 4 connected to the overlying bracket 3A which will in turn be arranged in a pre-loading configuration. The lateral appendage 18A of the overlying bracket 3A connected to its upper counterweight 4 slides in the respective slot 20 moving resting on the upper part of the slot 20.

When a second article is positioned on the overlying bracket 3A, it rotates in the loading position by actuating its upper counterweight 4 which in turn brings the upper bracket 3A to the pre-loading position.

This operation is repeated for each bracket 3A until all the brackets 3A of the column 1 are loaded with the stacked articles.

Unloading operations are carried out in the reverse order starting from the topmost bracket 3A. When an article is unloaded from a bracket 3A, it is returned to the inoperative raised position by the lower counterweight 4.

In other words, the lower counterweight 4 of each bracket 3A has the double function of actuator for rotating the bracket 3A from the inoperative position to the pre-loading position when an article is loaded onto the underlying bracket 3A, and of return member to return the bracket 3A from the loading position to the inoperative position when the article is removed.

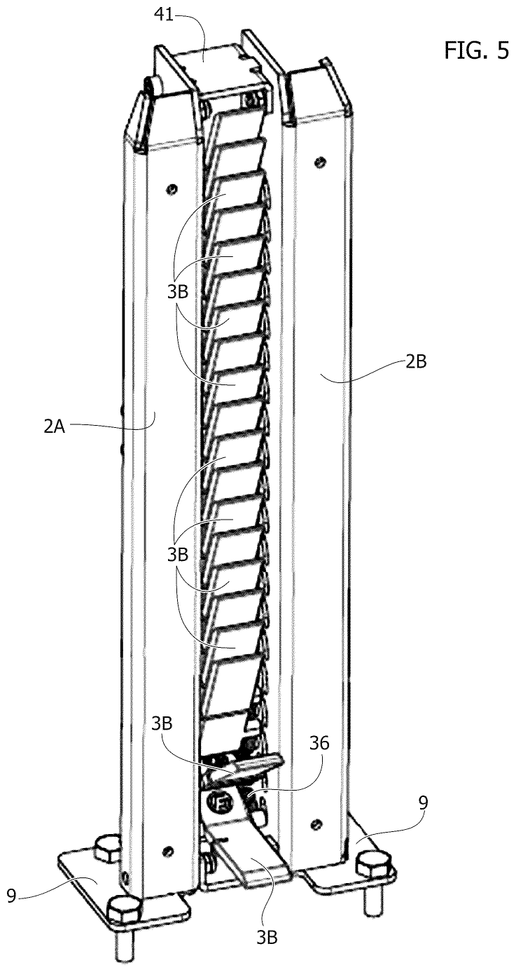

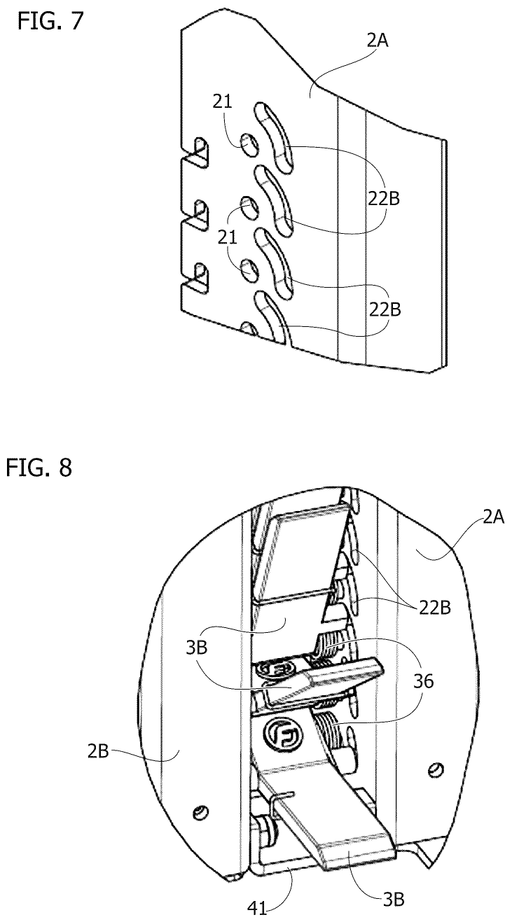

FIGS. 5-8, in which parts identical or similar to the ones described above are indicated using the same reference numerals, show a possible variant of the swingable bracket shown in FIG. 11 and indicated with 3B, of the grooves indicated with 22B, of the supports 34 for different return means 36, of the supports for the actuator means 18B, of the stop means 13B, and of the pivoting means 16B to the support 2.

In such variant, the pivoting of the bracket 3B to the support 2 is directly obtained by respective distal portions 16B of a pair of first lateral cylindrical bodies protruding from the rear body 23 of each bracket 3B, with the advantage of minimising the components of the column simplifying the assembly thereof. In this variant, the proximal portion 34 Of such lateral cylindrical bodies is coupled to the return means, torsion spring 36 in this case shown in FIG. 6.

Furthermore, the bracket 3B comprises a pair of second lateral cylindrical bodies 13B parallel to said first cylindrical bodies 16B, each provided with a proximal portion with larger diameter and a distal portion with smaller diameter 13B inserted into a respective groove 22B provided for on the support 2. Such groove 22B substantially consists of a curved slide section shaped to allow the distal portion 13B of the respective cylindrical body to pass through during the rotation of the bracket 3B; the end portions of the slide section are provided for the resting of the bracket 3B in the loading and inoperative positions. The actuator means, provided for controlling the rotation of the bracket 3B, as described with regard to the bracket 3A, consist of the protruding rear end portion of the bracket 3B provided with a thrust edge 18C designed to act against the edge 18C of the upper bracket 3B.

Advantageously, according to the invention, the aforementioned shapes of the brackets 3A and 3B are preferably obtained through a method for moulding plastic materials using, for example, an appropriate mould.

Now, with reference to FIG. 6, the support 2 may conveniently consist of a pair of crankcases 2A,2B each provided with the respective grooves 22A or 22B and connected to each other by means of appropriate fixing means, a plate 40 provided with bolts in the embodiment shown in the figures.

The column 1 thus described can be used together with at least one identical column, and preferably in an arrangement of four columns arranged at the vertices of a quadrilateral, in equipment for stacking and transporting piled-up articles such as for example vehicle body parts. Although in the case of the illustrated example the column 1 is oriented vertically, with the brackets which extend horizontally in the extracted position, alternative arrangements such as for example the ones in which the column is arranged horizontally, with the brackets which—in extracted position—can extend horizontally or vertically, and even in which the column is inclined with the brackets which extend vertically in the extracted position, fall within the scope of protection of the invention.

Obviously, the construction details and the embodiments may widely vary with respect to what has been described and illustrated, without departing from the scope of protection of the present invention as defined in the claims that follow. Therefore, for example, the counterweights associated with the brackets may be replaced by one or more traction springs tending to keep the brackets in the inoperative raised position.

1. A column for equipment for stacking and transporting piled-up and separated articles, comprising a channel-shaped support, a plurality of piled-up swingable brackets suitable to support the articles, each of said brackets being provided with:
a front body for supporting the articles,
a rear body provided with means for pivoting to the support so that the bracket can rotate between a retracted inoperative position, in which it is contained inside the support, an intermediate pre-loading position, in which the front body of the bracket is partially projecting from the support to receive an article, and an extracted loading position in which the front body is projecting transversely from said support to support the article, wherein said front body and said rear body are not coplanar,
stop means coplanar to the front body, each being inserted into a respective groove provided for on the support,
actuator means for controlling the rotation of the bracket from the retracted position to the intermediate pre-loading position by a contiguous bracket,
means for returning the bracket towards the retracted inoperative position,
supports for said actuator means and for said return means,
wherein said means for pivoting to the support, said stop means, said supports for the actuator means and for the return means are obtained in said rear body of the bracket,
wherein said rear body connects directly to said front body and said brackets are made of molded plastic material.

2. The column according to claim 1, wherein said rear body of each bracket comprises:
a lateral protuberance protruding from said rear body and provided with: a hole for a pivot pin inserted in a respective pair of holes provided for on the support defining said pivoting means, and stop surfaces each one being inserted into a respective groove provided for on the support, and
a rear protuberance provided with at least one lateral appendage coupled to said actuator and return means.

3. The column according to claim 1, wherein said rear body of each bracket comprises:
a pair of first lateral cylindrical bodies protruding from said rear body each having a proximal portion coupled to said return means, and a distal portion in the form of a pivot pin inserted into a respective hole provided for on the support,
a pair of second lateral cylindrical bodies parallel to said first cylindrical bodies, each provided with a proximal portion with larger diameter and a distal portion with smaller diameter inserted into a respective groove provided for on the support,
said groove having a curved slide section suitable to allow the distal portion of the respective cylindrical body to pass through—during the rotation of the bracket—between said inoperative and loading positions, and being provided with end portions for supporting the bracket respectively in said loading position and in the inoperative position, and
a rear end portion protruding superiorly providing an actuator means.

4. (canceled)

5. The column according to claim 1, wherein said support is formed by a pair of crankcases connected to each other by means of fixing means.

6. The column according to claim 1, wherein at least one of the end portions of said support has a pair of wings folded so as to define anchoring means for at least one end of said support.

7. The column according to claim 2, wherein said actuator means and said return means comprise respective counterweights.

8. The column according to claim 1, wherein said return means comprise a spring.

9. The column according to claim 5, wherein said return means comprise two counterweights respectively lower and upper, and in that each counterweight has an upper hole and a lower slot, wherein
the lower counterweight is connected to the lateral appendage of the bracket by means of the respective upper hole and to the lateral appendage of the underlying bracket by means of the respective lower slot, and
the upper counterweight is connected to the lateral appendages of the bracket by means of the respective lower slot and to the lateral appendage of the overlying bracket by means of the respective upper hole.

10. The column according to claim 1, wherein said rear body of each of the brackets is inclined with respect to said front body.

11. Equipment for stacking and transporting piled-up articles, comprising at least two columns according to the column of claim 1.

12. Equipment according to claim 11, wherein said columns are vertical and said brackets in said extracted position extend horizontally.

13. Equipment according to claim 11, wherein said columns are horizontal and said brackets in said extracted position extend horizontally.

14. Equipment according to claim 11, wherein said columns are horizontal and said brackets in said extracted position extend vertically.

15. Equipment according to claim 11, wherein said columns are inclined and said brackets in said extracted position extend vertically.
